(19) United States
(12) Patent Application Publication
(10) Pub. No.: US 2024/0426711 A1
(43) Pub. Date: Dec. 26, 2024

(54) FAILURE DETECTION IN SOLAR COLLECTORS

(71) Applicant: ACWA POWER Company, Riyadh (SA)

(72) Inventors: Hiba DERNAYKA, Dubai (AE); Jalil BOUKAABA, Ouarzazate (MA); Hicham ZOUITEN, Ouarzazate (MA); Matthew YORK, Dubai (AE); Lana ELCHAAR, Dubai (AE); Ahmed ALI, Dubai (AE)

(73) Assignee: ACWA POWER Company, Riyadh (SA)

(21) Appl. No.: 18/749,210

(22) Filed: Jun. 20, 2024

Related U.S. Application Data
(60) Provisional application No. 63/509,514, filed on Jun. 21, 2023.

(51) Int. Cl. G01M 99/00

(52) U.S. Cl. CPC G01M 99/008

(57) ABSTRACT

A system for failure detection in solar collectors receives first retraction data including a first retraction time associated with a first retraction process of a solar collector from a first position to a second position. The system also retrieves reference data including a reference retraction time associated with a reference retraction process of the solar collector from the first position to the second position based on the received first retraction data. The system also calculates a first settling time associated with the first retraction process of the solar collector based on the first retraction time and the reference retraction time. The system also detects a first anomaly in a functionality of one or more joints of the solar collector based on the calculated first settling time. The system also outputs a first alert based on the detected first anomaly.

### CROSS-REFERENCE TO RELATED APPLICATIONS

This application claims priority to U.S. Provisional Patent Application Ser. No. 63/509,514, filed Jun. 21, 2023, and entitled “SYSTEM AND METHOD FOR FAILURE DETECTION IN SOLAR POWER SYSTEM”, the disclosure of which is incorporated herein by reference.

### TECHNOLOGICAL FIELD

The disclosure relates to solar power systems and more particularly relates to failure detection in concentrating solar collectors of solar power systems.

### BACKGROUND

Solar power systems, also known as photovoltaic (PV) systems or solar power systems, are electric power systems designed to harness solar energy from sunlight and convert it into usable electricity. Such systems include various components, including solar collectors that reflect the sun light either into a receiver or tubes, a solar inverter that transforms the output from direct to alternating current, mounting structures, cabling, and other electrical accessories necessary for a functional setup. Typically, the solar collectors are in the form of mirrors that focuses the sunlight onto the receiver or tubes where a heat transfer fluid (HTF) circulates and absorbs the heat. Such heat is further used to generate electricity or provide industrial process heat.

The solar power systems also include solar trackers. Such solar trackers are devices that orient a payload, such as the solar collectors, towards the sun to minimize the angle of incidence between the incoming sunlight and the solar collector, which increases the amount of energy produced from a fixed amount of installed power-generating capacity. To track the sunlight, a movable part of the solar collector may rotate at different angles. Such rotation of the movable part of the concentrating solar collector may be facilitated by joints, for example, ball joints.

Improper functioning of joints in solar collectors can lead to misalignment issues, reducing efficiency by hindering optimal sunlight absorption. If the solar collector fails to accurately track the sun, it may generate less power than when properly aligned, resulting in decreased energy production. Additionally, joint malfunctions can cause hydraulic fluid leaks, potentially disrupting the operation of the solar collectors and posing environmental risks due to the toxic nature of the fluid. Preventing ball joint failures is crucial to maintaining the proper functioning of solar collectors and ensuring environmental safety.

Conventionally, to detect issues within the ball joints of the solar collector, manual monitoring and check-ups may have to be performed on the ball joints and/or the solar collector. However, such manual monitoring and check-ups are not feasible for the solar power system having a large number, such as thousands of solar collectors. Therefore, there is a need for a system that can automatically detect issues with the ball joints of the solar collector without a need for manual monitoring.

### SUMMARY

A system, a method, and a computer programmable product are provided for implementing the process of failure detection in solar collectors.

In one aspect, a system for failure detection in solar collectors is disclosed. The system includes a memory configured to store a computer-executable instruction; and one or more processors coupled to the memory, wherein the one or more processors are configured to receive first retraction data including a first retraction time associated with a first retraction process of a solar collector from a first position to a second position. The one or more processors may be further configured to retrieve reference data including a reference retraction time associated with a reference retraction process of the solar collector from the first position to the second position based on the received first retraction data. The one or more processors may be further configured to calculate a first settling time associated with the first retraction process of the solar collector based on the first retraction time and the reference retraction time. Further, the one or more processors may be configured to detect a first anomaly in a functionality of one or more joints of the solar collector based on the calculated first settling time. The one or more processors may be further configured to output a first alert based on the detected first anomaly.

In additional system embodiments, the one or more processors may be further configured to receive second retraction data including a second retraction time associated with a second retraction process of the solar collector from the first position to the second position. The first retraction process occurs at a first time and the second retraction process occurs at a second time. The one or more processors may be further configured to calculate a second settling time associated with the second retraction process of the solar collector based on the second retraction time and the reference retraction time. Further, the one or more processors may be configured to detect a second anomaly in the functionality of the one or more joints of the solar collector based on the calculated second settling time. The one or more processors may be further configured to output a second alert based on the detected second anomaly.

In additional system embodiments, the one or more processors may be further configured to detect a failure in the functionality of the one or more joints of the solar collector based on the detected first anomaly and the detected second anomaly. Further, the one or more processors may be configured to output a failure alert based on the detected failure of the one or more joints of the solar collector.

In additional system embodiments, the first retraction data associated with the first retraction process of the solar collector further includes at least one of first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.

In additional system embodiments, the reference data associated with the solar collector further includes at least one of first position information associated with the first position of the solar collector, second position information associated with the second position of the solar collector, or a reference retraction slope of the solar collector.

In additional system embodiments, the one or more processors may be further configured to compare the first settling time associated with the first retraction process of the solar collector with a threshold settling time. Further, the one or more processors may be configured to detect the first anomaly in the functionality of the one or more joints of the solar collector based on the comparison.

In additional system embodiments, the one or more processors may be further configured to detect the first anomaly in the functionality of the one or more joints of the solar collector based on a determination that the first settling time may be greater than the threshold settling time.

In additional system embodiments, the one or more processors may be further configured to receive a user input associated with an initiation of the first retraction process of the solar collector from the first position to the second position. Further, the one or more processors may be configured to receive the first retraction data based on the received user input.

In additional system embodiments, the one or more processors may be further configured to store the calculated first settling time associated with the first retraction process of the solar collector in one or more databases.

In another aspect, a method for failure detection in solar collectors is disclosed. The method includes receiving first retraction data including a first retraction time associated with a first retraction process of a solar collector from a first position to a second position. The method may further include retrieving reference data including a reference retraction time associated with a reference retraction process of the solar collector from the first position to the second position based on the received first retraction data. Further, the method may include calculating a first settling time associated with the first retraction process of the solar collector based on the first retraction time and the reference retraction time. The method may further include detecting a first anomaly in a functionality of one or more joints of the solar collector based on the calculated first settling time. Further, the method may include outputting a first alert based on the detected first anomaly.

In additional method embodiments, the method may further include receiving second retraction data including a second retraction time associated with a second retraction process of the solar collector from the first position to the second position. The first retraction process occurs at a first time and the second retraction process occurs at a second time. The method may further include calculating a second settling time associated with the second retraction process of the solar collector based on the second retraction time and the reference retraction time. Further, the method may include detecting a second anomaly in the functionality of the one or more joints of the solar collector based on the calculated second settling time. The method may further include outputting a second alert based on the detected second anomaly.

In additional method embodiments, the method may further include detecting a failure in the functionality of the one or more joints of the solar collector based on the detected first anomaly and the detected second anomaly. Further, the method may include outputting a failure alert based on the detected failure of the one or more joints of the solar collector.

In additional method embodiments, the first retraction data associated with the first retraction process of the solar collector further includes at least one of first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.

In additional method embodiments, the reference data associated with the solar collector further includes at least one of first position information associated with the first position of the solar collector, second position information associated with the second position of the solar collector, or a reference retraction slope of the solar collector.

In additional method embodiments, the method may further include comparing the first settling time associated with the first retraction process of the solar collector with a threshold settling time. Further, the method may include detecting the first anomaly in the functionality of the one or more joints of the solar collector based on the comparison.

In additional method embodiments, the method may further include detecting the first anomaly in the functionality of the one or more joints of the solar collector based on a determination that the first settling time may be greater than the threshold settling time.

In additional method embodiments, the method may further include receiving a user input associated with an initiation of the first retraction process of the solar collector from the first position to the second position. Further, the method may include receiving the first retraction data based on the received user input.

In additional method embodiments, the method may further include storing the calculated first settling time associated with the first retraction process of the solar collector in one or more databases.

In yet another aspect, a computer program product comprising a non-transitory computer readable medium having stored thereon computer executable instructions which when executed by at least one processor, cause the processor to carry out operations for failure detection in solar collectors. The operations include receiving first retraction data including a first retraction time associated with a first retraction process of a solar collector from a first position to a second position. The operations may further include retrieving reference data including a reference retraction time associated with a reference retraction process of the solar collector from the first position to the second position based on the received first retraction data. Further, the operations may include calculating a first settling time associated with the first retraction process of the solar collector based on the first retraction time and the reference retraction time. The operations may further include detecting a first anomaly in a functionality of one or more joints of the solar collector based on the calculated first settling time. Further, the operations may include outputting a first alert based on the detected first anomaly.

In additional computer program product embodiments, the operations may further include the first retraction data associated with the first retraction process of the solar collector including at least one of first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for failure detection in solar collectors, in accordance with an embodiment of the disclosure;

FIG. 2 illustrates a block diagram of the system of FIG. 1, in accordance with an embodiment of the disclosure;

FIG. 3 is a diagram that illustrates exemplary operations for failure detection in solar collectors, in accordance with an embodiment of the disclosure;

FIG. 4 is a flowchart that illustrates an exemplary method for failure detection in solar collectors, in accordance with an embodiment of the disclosure;

FIG. 5 illustrates exemplary alerts on the user device, in accordance with an embodiment of the disclosure;

FIG. 6A illustrates a graphical representation depicting an ideal retraction process of the solar collector in accordance with an example embodiment.

FIG. 6B illustrates a graphical representation depicting an anomaly in retraction process of the solar collector in accordance with an example embodiment of the disclosure; and

FIG. 7 is a flowchart that illustrates an exemplary method for failure detection in solar collectors, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

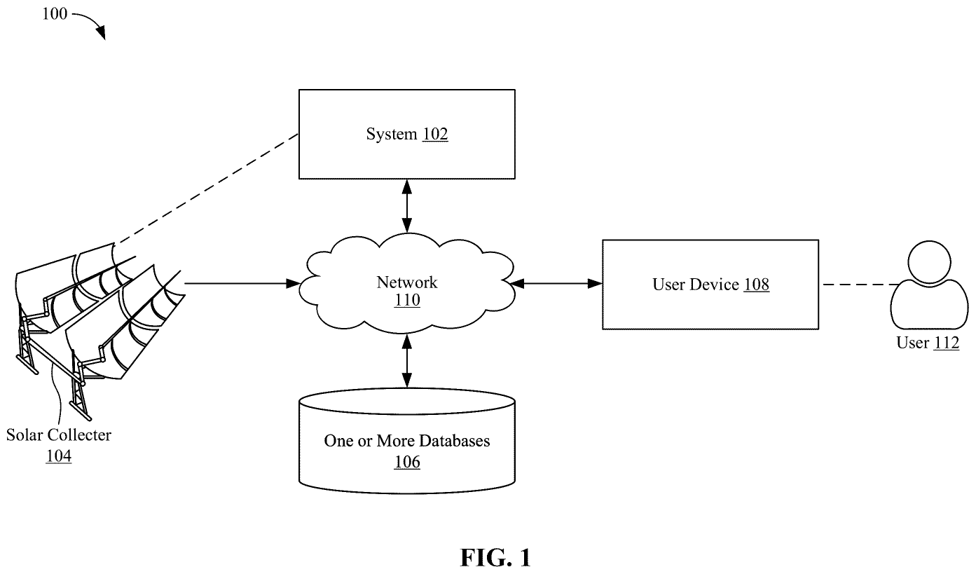

FIG. 1 is a diagram that illustrates a network environment 100 for failure detection in solar collectors, in accordance with an embodiment of the disclosure. With reference to FIG. 1, there is shown a diagram of the network environment 100. The network environment 100 includes a system 102, a solar collector 104, one or more databases 106, a user device 108, a network 110, and a user 112.

The system 102 may include suitable logic, circuitry, interfaces, and/or code that may be configured to detect failure in the solar collectors. The system 102 may be configured to receive first retraction data including a first retraction time associated with a first retraction process of the solar collector 104 from a first position to a second position. The system 102 may be further configured to retrieve reference data including a reference retraction time associated with a retraction process of the solar collector 104 from the first position to the second position based on the received first retraction data. Further, the system 102 may be configured to calculate a first settling time associated with the first retraction process of the solar collector 104 based on the first retraction time and the reference retraction time. The system 102 may be further configured to detect a first anomaly in a functionality of one or more joints of the solar collector 104 based on the first settling time. Further, the system 102 may be configured to output a first alert based on the detected first anomaly.

The solar collector 104 may be a device that may collect and/or concentrate solar radiation from the sun, primarily used for active solar heating and water heating. In an embodiment, the solar collector 104 may be mounted on the roofs or may be installed in solar power plants. The solar collector 104 may be categorized into various types for example, but not limited to, a non-concentrating solar collector, and a concentrating solar collector. In an embodiment, the solar collector 104 may be the concentrating solar collector, such as, but not limited to, a line focus collector (parabolic troughs). The line focus collector may use highly reflective materials to collect and concentrate heat energy from solar radiation. The concentrating solar collector may be composed of parabolically shaped reflective sections connected into a long trough, with a pipe carrying water placed in the center of the solar collector 104. The heat from such line focus collector may be generally used for driving Stirling engines or converting solar energy directly into electricity with high-efficiency photovoltaic cells.

In an alternate embodiment, the solar collector 104 may be the non-concentrating solar collector or an evacuated tube collector. The non-concentrating solar collector, such as, but not limited to, a flat-plate collector. The non-concentrating solar collector may have an aperture and an absorber. Further, the flat-plate collector may consist of an enclosure containing a dark-colored absorber plate with fluid circulation passageways. The absorber plate may be often coated to maximize solar energy absorption, while the top of the box may have a transparent cover that may allow solar energy to pass through but may limit heat energy loss. In an exemplary embodiment, the evacuated tube collectors may be another type of the non-concentrating solar collector, where the solar collection material may be placed inside a glass tube with little to no air inside. In an embodiment, liquid-filled pipes in the vacuum-sealed glass container are heated by the solar collector, allowing for energy delivery.

In an embodiment, the aperture, and the absorber of the solar collector 104 may have to be moved or rotated for tracking the sun during the day to maximize energy output. In an exemplary embodiment, a tracking system may be installed within the solar collector 104. The tracking system may include one or more joints to cause rotation of a movable part (typically, the aperture and the absorber) of the solar collector 104 at different angles for tracking the sunlight and harvesting solar power from the sunlight. Examples of a tracking technique used by the tracking system may include, but are not limited to, a passive tracking system, an active tracking system, an open-loop tracking system, a single-axis tracking system, a dual-axis tracking system, a timed tracking system, an altitude or azimuth tracking system, or a combination thereof.

In an embodiment, the system 102 may be configured to retrieve reference data from the one or more databases 106 via the network 110. The one or more databases 106 may include the reference data. In an embodiment, the reference data associated with the solar collector 104 may include at least one of a first position information associated with the first position of the solar collector 104, a second position information associated with the second position of the solar collector 104, or a reference retraction slope of the solar collector 104.

Each of the one or more databases 106 includes suitable logic, circuitry, interfaces, and/or code that may be configured to organize the collection of data stored in a computer (say the system 102), typically in the form of tables with rows and columns. The one or more databases may include various databases such as, but not limited to, a first database, and a second database. Further, the one or more databases 106 may include, a first table, and a second table. The one or more databases 106 may be managed by a database management system (DBMS) that may facilitate data entry, storage, retrieval, and organization. The one or more databases 106 may power various applications online and offline, storing different types of data such as, but not limited to, the first retraction data, the reference data, and the second retraction data. In an embodiment, each of the one or more databases 106 may correspond to one of a relational (SQL) database or non-a relational (NoSQL) database, offering different query languages and data organization methods. The one or more databases 106 may support transactional and analytical data processing, enabling real-time recording of activities and informed decision-making through data analysis.

In another embodiment, the one or more databases 106 may include the second retraction data. The second retraction data may be the historical data associated with the solar collector 104. In an exemplary embodiment, if the system 102 receives the first retraction data associated with the solar collector 104 on a current day of operation of the solar collector 104, then the historical data may be the second retraction data associated with the solar collector 104 that may be received by the system 102 in a historical time period. The historical time period may be, for example, but not limited to, 1 day before the current day of operation, 2 days before the current day of operation, 3 days before the current day of operation, 1 week before the current day of operation, 2 weeks before the current day of operation, 4 weeks before the current day of operation, 1 month before the current day of operation, 1 year before the current day of operation and the like.

In an exemplary embodiment, the reference data and the historical data may be stored in the one or more databases 106 in the form of one or more tables. In another exemplary embodiment, the reference data and the historical data may be stored in the one or more databases 106 in the form of one or more tables. The reference data associated with the first retraction process of the solar collector 104 may be stored in a first table in one or more databases 106. Further, the historical data associated with the second retraction process of the solar collector 104 may be stored in a second table in the one or more databases 106. In yet another exemplary embodiment, the reference data associated with the first retraction process of the solar collector 104 may be stored in a first database in the one or more databases 106. Further, the historical data associated with the second retraction process of the solar collector 104 may be stored in a second database in the one or more databases 106.

The system 102 may be communicatively coupled to each of the system 102, the solar collector 104, the one or more databases 106, and the user device 108, via the network 110. In an embodiment, the system 102 may be communicatively coupled to other components not shown in FIG. 1 via the network 110. All the components in the network environment 100 may be coupled directly or indirectly to the network 110. The components described in the network environment 100 may be further broken down into more than one component and/or combined in any suitable arrangement. Further, one or more components may be rearranged, changed, added, and/or removed.

The network 110 may be wired, wireless, or any combination of wired and wireless communication networks, such as cellular, Wi-Fi, internet, local area networks, or the like. In some embodiments, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network. It may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the system 102 may be configured to receive the first retraction data associated with the first retraction process of the solar collector 104 from the first position to the second position. The first retraction data may include the first retraction time. In an embodiment, the first retraction process may be triggered when a mode of the solar collector 104 may be changed from a tracking mode to a stop mode, or when the sun sets in the west, i.e., the solar collector 104 may fail to receive any more sunlight at any angle. Once the first retraction process is triggered, the solar collector 104 may come back to the second position from the first position. In an exemplary embodiment, the first retraction process for the solar collector 104 may indicate the movement of the solar collector 104 from the first position to the second position. The first position may be, for example, a tracking position of the solar collector 104. Further, the second position may be an initial position of the solar collector 104. The tracking position may correspond to a position at which the solar collector 104 stops tracking the movement of the sun or at which the retraction process is triggered. The tracking position of the solar collector 104 may have a tracking angle that may be attained by the solar collector 104 while tracking the movement of the sun. Moreover, the initial position of the solar collector 104 may have a rest angle that may be attained by the solar collector 104 when the solar collector 104 stops tracking the movement of the sun (i.e. it comes to rest).

Further, the system 102 may be configured to retrieve the reference data that may include the reference retraction time associated with the retraction process of the solar collector 104 from the first position to the second position based on the received first retraction data. In an embodiment, the system 102 may be configured to retrieve, over the network 110, the reference data that may be stored in the one or more databases 106. In an embodiment, the reference data associated with the solar collector 104 may include, but is not limited to, first position information associated with the first position of the solar collector 104, second position information associated with the second position of the solar collector 104, or a reference retraction slope of the solar collector 104.

In an embodiment, the system 102 may be further configured to calculate the first settling time associated with the first retraction process of the solar collector 104 based on the first retraction time associated with the first retraction process of the solar collector 104 and the reference retraction time. In an exemplary embodiment, the first settling time may indicate an excess amount of time over the reference retraction time that may be taken by the solar collector 104 to attain the second position from the first position. For example, if the reference retraction time taken by the solar collector 104 to attain the second position from the first position may be for example, but not limited to, 20 seconds, and the first retraction time associated with the first retraction process of the solar collector 104 to attain the second position from the first position may be for example, but not limited to 30 seconds, then the excess time over the reference retraction time maybe 10 seconds. The excess time of 10 seconds may be the first settling time.

Further, the system 102 may be configured to detect a first anomaly in a functionality of the one or more joints of the solar collector 104 based on the calculated first settling time. The one or more joints may be, for example, but are not limited to, ball joints. The ball joints may cause rotation of the movable part (typically, the aperture and the absorber) of the solar collector 104 at different angles for tracking the sunlight and harvesting solar power from that place. In an exemplary embodiment, the system 102 may detect the first anomaly in the functionality of the one or more joints of the solar collector 104 by comparing the first settling time associated with the first retraction process of the solar collector 104 with a threshold settling time. For example, if the first settling time is 10 seconds and the threshold settling time is 5 seconds, then the system 102 may detect that the first settling time associated with the first retraction process is greater than the threshold settling time by 5 seconds. Further, the system 102 may detect the first anomaly in the functionality of the one or more joints of the solar collector 104 based on the determination that the first settling time is greater than the threshold settling time. In an embodiment, the threshold settling time may be specified within a defined threshold range. In an exemplary embodiment, if the first settling time may be within the defined threshold range, then the system 102 may not generate the first anomaly alert and the functionality of the one or more joints of the solar collector 104 may be considered healthy. In another exemplary embodiment, if the first settling time may be greater than the defined threshold range, then the system 102 may generate the first anomaly alert.

In an embodiment, the system 102 may be further configured to output the first alert based on the detected first anomaly. In an exemplary embodiment, the system 102 may output the first alert on the user device 108. The user device 108 may be associated with the user 112. The user device 108 may be, for example, but not limited to, a computing device, a mainframe machine, a server, a computer workstation, a smartphone, a cellular phone, a mobile phone, a gaming device, or a consumer electronic (CE) device. The user 112 may be an individual or a group of individuals handling operations of the solar collector 104.

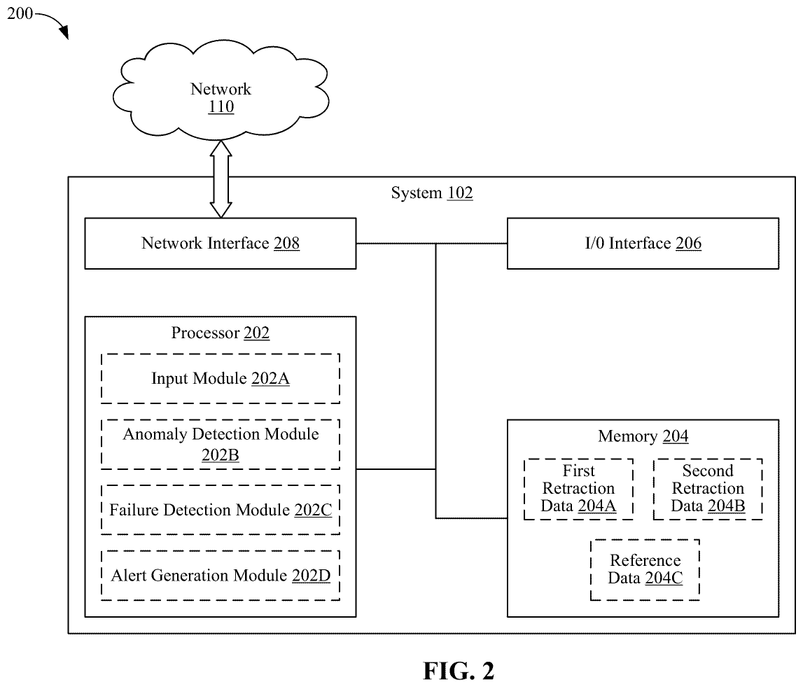

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a network interface 208. The processor 202 may comprise modules, depicted as, an input module 202A, an anomaly detection module 202B, a failure detection module 202C, and an alert generation module 202D. The processor 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A, and the alert generation module 202D may be integrated within the I/O interface 206. In some embodiments, the input module 202A may receive input data (such as user inputs) and the alert generation module 202D may output alerts (such as the first alert, a second alert a failure alert, and the like) via the I/O interface 206.

The processor 202 of the system 102 may be configured to receive the first retraction data 204A, retrieve the reference data 204C, calculate the first settling time, detect the first anomaly, and output the first alert based on the detected first anomaly. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the network interface 208 of the system 102. The network interface 208 may provide an interface for accessing various features and data stored in the system 102.

In some embodiments, the processor 202 may be configured to provide Internet-of-Things (IoT) related capabilities to users of the system 102 disclosed herein. The I/O interface 206 may provide an interface for accessing various features and data stored in the system 102.

The input module 202A of the processor 202 may be configured to receive the first retraction data 204A. The first retraction data 204A may include the first retraction time associated with the first retraction process of the solar collector 104 from the first position to the second position. In an embodiment, the first retraction data 204A may be received from one or more sensors associated with the solar collector 104. The one or more sensors may include, for example, but are not limited to, one or more solar radiation sensors, specifically pyranometers, one or more position sensors, and one or more temperature sensors. In an exemplary embodiment, the one or more sensors may receive the first retraction data based on changes in the position or the angle of the solar collector 104 with respect to time during the first retraction process from the first position to the second position, or time taken to complete the first retraction process.

Further, the input module 202A may be configured to retrieve the reference data 204C. The reference data 204C may include the reference retraction time associated with a reference retraction process of the solar collector 104 from the first position to the second position. In an embodiment, the reference data 204C may be retrieved from the one or more databases 106. In an exemplary embodiment, the reference data 204C may be a predefined dataset that may be associated with the optimal performance of the solar collector 104.

The anomaly detection module 202B of the processor 202 may be configured to calculate the first settling time associated with the first retraction process of the solar collector 104. In an embodiment, the first settling time may be calculated based on a comparison of the first retraction time and the reference retraction time. In another embodiment, the calculated first settling time may further be compared with the threshold settling time. Further, the first anomaly in the functionality of the one or more joints may be detected based on the comparison of the calculated first settling time and the threshold settling time.

In an exemplary embodiment, the first retraction time may be 10 seconds and the reference retraction time may be 5 seconds. Further, the first retraction time may be compared with the reference retraction time for calculating the first settling time. The calculated first settling time maybe 5 seconds. The threshold settling time maybe 3 seconds. Further, the calculated first setting time (5 seconds) may be compared with the threshold settling time (3 seconds). The first anomaly in the functionality of the one or more joints of the solar collector 104 may be detected based on the calculated first settling time being greater than the threshold settling time.

The failure detection module 202C of the processor 202 may be configured to detect the failure in the functionality of the one or more joints of the solar collector 104. The failure in the functionality of the one or more joints of the solar collector 104 may be detected based on the detected first anomaly in the functionality of the one or more joints of the solar collector 104 during the first retraction process and the detected second anomaly in the functionality of the one or more joints of the solar collector 104 during the second retraction process.

In an exemplary embodiment, if the first anomaly in the functionality of the one or more joints of the solar collector 104 is detected during the first retraction process on a current day of operation and the second anomaly in the functionality of the one or more joints of the solar collector 104 is detected during the second retraction process during the historical time period (say yesterday) then, the failure is detected in the functionality of the one or more joints of the solar collector 104. In another exemplary embodiment, if the anomaly detection module 202B detects the first anomaly in the functionality of the one or more joints of the solar collector 104 on the current day of operation and if the anomaly detection module 202B has already detected the second anomaly in the functionality of the one or more joints of the solar collector 104 previously (like yesterday or twice in last week), then the failure detection module 202C may detect the failure in the functionality of the one or more joints of the solar collector 104.

The alert generation module 202D of the processor 202 may be configured to output the first alert, the second alert, and the failure alert. In an embodiment, the first alert, the second alert, and the failure alert may be outputted based on the detected first anomaly in the functionality of the one or more joints of the solar collector 104, the detected second anomaly in the functionality of the one or more joints of the solar collector 104, and the detected failure in the functionality of the one or more joints of the solar collector 104 respectively. The alert generation module 202D may output the first alert, the second alert, and the failure alert on the user device 108 associated with the user 112.

The memory 204 of the system 102 may be configured to store the first retraction data 204A, the second retraction data 204B, and the reference data 204C. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In an embodiment, the first retraction data 204A may include the first retraction time associated with the first retraction process of the solar collector 104 from the first position to the second position. The first retraction data 204A may further include, but is not limited to, the first position information associated with the first position of the solar collector 104, the second position information associated with the second position of the solar collector 104, the first timestamp associated with the initiation of the first retraction process of the solar collector 104, the second timestamp associated with the ending of the first retraction process of the solar collector 104, the speed information associated with the first retraction process of the solar collector 104, or the slope information associated with the solar collector 104.

In an embodiment, the second retraction data 204B may include the second retraction time associated with the second retraction process of the solar collector 104 from the first position to the second position. The second retraction data 204B may include, but is not limited to, the historical data of the historical retraction process associated with the solar collector 104. In an embodiment, the reference data 204C may include the reference retraction time associated with the reference retraction process of the solar collector 104 from the first position to the second position. The reference data 204C may include, but is not limited to, the first position information associated with the first position of the solar collector 104, the second position information associated with the second position of the solar collector 104, or a reference retraction slope of the solar collector 104.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202.

The network interface 208 may comprise input interface and output interface for supporting communications to and from the system 102 or any other component with which the system 102 may communicate. The network interface 208 may be any means such as a device or circuitry embodied in either hardware or a combination of hardware and software that is configured to receive and/or transmit data to/from a communications device in communication with the system 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB) or other mechanisms.

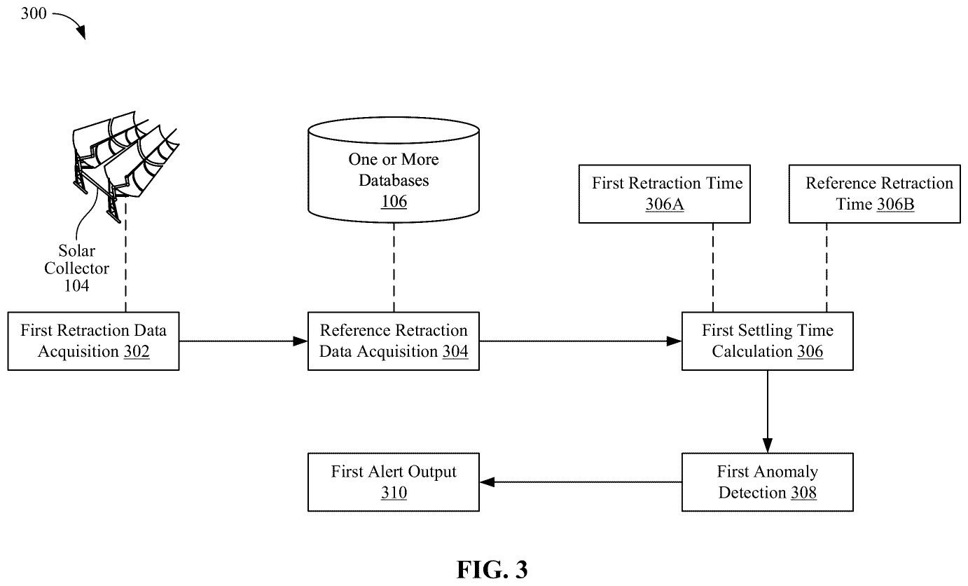

FIG. 3 is a diagram 300 that illustrates exemplary operations for failure detection in solar collectors, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 310, as described herein. The exemplary operations illustrated in the block diagram 300 may start at 302 and may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the implementation.

At 302, a first retraction data acquisition operation may be executed. In the first retraction data acquisition operation, the system 102 may be configured to receive the first retraction data 204A associated with the first retraction process of the solar collector 104 from the first position to the second position. In an embodiment, the first position may be the tracking position associated with the solar collector 104 and the second position may be the initial position associated with the solar collector 104. By way of example, in the first position, the solar collector 104 may be facing towards the west whereas in the second position, the solar collector 104 may be facing towards the east because the sun sets in the west. After the sunset, the first retraction process may start, and the first retraction data may be collected.

The first retraction data 204A associated with the first retraction process of the solar collector 104 may include at least one of the first position information associated with the first position of the solar collector 104, the second position information associated with the second position of the solar collector 104, the first timestamp associated with an initiation of the first retraction process of the solar collector 104, the second timestamp associated with an ending of the first retraction process of the solar collector 104, the speed information associated with the first retraction process of the solar collector 104, or the slope information associated with the solar collector 104. In an embodiment, the system 102 may be configured to receive the user 112 input associated with an initiation of the first retraction process of the solar collector 104 from the first position (i.e. west side) to the second position (i.e. east side).

In an embodiment, the first position information associated with the first position of the solar collector 104 may be associated with the tracking position of the solar collector 104. Further, the second position information associated with the second position of the solar collector 104 may be associated with the initial position of the solar collector 104. In an exemplary embodiment, if the first retraction process associated with solar collector 104 may be initiated when the solar collector 104 fails to receive any sunlight at any angle, then the position of the solar collector 104 at which the first retraction process is initiated may be the first position. The information associated with the first position of the solar collector 104 may be the first position information and may include, but is not limited to, the angle of solar collector 104 at the first position. Further, the first retraction process may end, and the solar collector 104 may come to rest or its initial position. The rest position or the initial position of the solar collector 104 may be the second position of the solar collector 104. The information associated with the second position of the solar collector 104 may be the second position information and may include, but is not limited to, the angle of solar collector 104 at the second position.

Further, the first time at which the first retraction process of the solar collector 104 is initiated may correspond to the first timestamp associated with the initiation of the first retraction process of the solar collector 104. A second time at which the first retraction process of the solar collector 104 ends may correspond to the second timestamp associated with the ending of the first retraction process of the solar collector 104.

In an exemplary embodiment, if the solar collector 104 fails to receive any sunlight at any angle, then the first retraction process is initiated. The first time may be, for example, 18:15:00. The first timestamp associated with the initiation of the first retraction process of the solar collector 104 may be 18:15:00. Further, once the solar collector 104 may attain the second position at the second time, the first retraction process of the solar collector 104 may end. The second time may be, for example, but not limited to, 18:16:00. The second timestamp associated with the ending of the first retraction process of the solar collector 104 may be 18:16:00.

In another exemplary embodiment, the system 102 may be configured to receive the user input from the user 112. The user input may be associated with the initiation of the first retraction process of the solar collector 104 from the first position to the second position. If the user 112 initiates the first retraction process of the solar collector 104 at the first time, where the first time may be 14:10:00, then the first timestamp associated with the initiation of the first retraction process of the solar collector 104 may be 14:10:00. Further, once the solar collector 104 attains the second position at the second time, the first retraction process of the solar collector 104 may end and the second timestamp may be determined. The second timestamp associated with the ending of the first retraction process of the solar collector 104 may be 14:11:00.

In an embodiment, the first retraction data 204A may further include the speed information associated with the first retraction process of the solar collector 104. The speed information may indicate a speed with which the solar collector 104 may move from the second position to the first position during the first retraction process of the solar collector 104. Further, the first retraction data 204A may include the slope information associated with the solar collector 104. The slope information may indicate a change in the angle of the solar collector 104 overtime during the first retraction process. The slope information may indicate a retraction speed of the movable part of the solar collector 104. In an exemplary embodiment, based on the first retraction time 306A being less than or equal to the reference retraction time, a value associated with the slope information of the first retraction process may be high. This may indicate that a value associated with the speed information of the solar collector 104 may be high, further indicating the normal behaviour of the one or more joints of the solar collector 104. In another exemplary embodiment, based on the first retraction time 306A being more than the reference retraction time, the value associated with the slope information of the first retraction process may be low. This may indicate that the value associated with the speed information of the solar collector 104 may be less, further indicating the anomaly in the functionality of the one or more joints of the solar collector 104.

At 304, a reference data acquisition operation may be executed. In the first retraction data acquisition operation, the system 102 may be configured to retrieve the reference data 204C associated with the retraction process of the solar collector 104 from the first position to the second position. The reference data may include the reference retraction time, the first position information associated with the first position of the solar collector 104, the second position information associated with the second position of the solar collector 104, or the reference retraction slope of the solar collector 104. In an exemplary embodiment, the reference data 204C may be stored in the one or more databases 106.

In an embodiment, the reference retraction time may correspond to an ideal retraction time for completing the retraction process of the solar collector 104. For example, the reference retraction time of the solar collector 104 may be, but is not limited to, 30 seconds. Further, the reference retraction slope of the solar collector 104 may be an ideal retraction slope for the retraction process of the solar collector 104. The reference retraction slope may indicate a reference retraction speed of the movable part of the solar collector 104.

At 306, a first settling time calculation operation may be executed. In the first settling time calculation operation, the system 102 may be configured to calculate the first settling time associated with the first retraction process of the solar collector 104 based on the first retraction time 306A and the reference retraction time 306B. In an embodiment, the first retraction time 306A may be associated with the first retraction data 204A. Further, the reference retraction time 306B may be associated with the reference data 204C. The system 102 may be configured to calculate the first settling time of the solar collector 104 by determining the first retraction time 306A and the reference retraction time 306B.

For example, if the solar collector 104 may take 30 seconds to attain the second position from the first position, then the first retraction time 306A of the solar collector maybe 30 seconds. Further, the system 102 may retrieve the reference retraction time 306B associated with the reference data 204C from the one or more databases 106. The retrieved reference retraction time may be, for example, 20 seconds. The system 102 may calculate the first settling time associated with the first retraction process of the solar collector 104 based on the first retraction time 306A and the reference retraction time 306B. Specifically, the first settling time may correspond to the difference between the reference retraction time and the first retraction time 306A. Therefore, the calculated first settling time associated with the first retraction process of the solar collector 104 may be 10 seconds. The first settling time may indicate that the solar collector 104 may take 10 seconds more than the ideal retraction time of the solar collector 104. In an embodiment, the system 102 may be further configured to store the calculated first settling time associated with the first retraction process of the solar collector 104 in the one or more databases 106.

At 308, a first anomaly detection operation may be executed. In the first anomaly detection operation, the system 102 may be configured to detect the first anomaly in the functionality of the one or more joints of the solar collector 104 based on the calculated first settling time. The system 102 may be configured to compare the first settling time associated with the first retraction process of the solar collector 104 with the threshold settling value. For example, the first settling time of the first retraction process of the solar collector 104 may be 10 seconds and the threshold settling time may be 5 seconds. Further, the system 102 may compare the first settling time with the threshold settling time. The system 102 may be further configured to detect the first anomaly in the functionality of the one or more joints of the solar collector 104 based on the comparison. In an exemplary embodiment, based on the first settling time being greater than the threshold settling time, the system. 102 may detect the first anomaly in the functionality of the one or more joints of the solar collector 104. The first anomaly in the functionality of the one or more joints of the solar collector 104 may indicate inefficiency in the functionality of the one or more joints of the solar collector 104. Therefore, if the first settling time is greater than the threshold settling time, then it may be deemed that the first anomaly may be detected.

In an embodiment, the threshold settling time may be specified within the defined threshold range. The defined threshold range for the threshold settling time may include an upper threshold limit and a lower threshold limit. For example, the upper threshold limit may be, 12 seconds, and the lower threshold limit may be, 10 seconds. In an exemplary embodiment, if the first settling time may be less than the upper threshold limit and greater than the lower threshold limit, then the system 102 may not generate the first anomaly alert and the functionality of the one or more joints of the solar collector 104 may be considered healthy. In another exemplary embodiment, if the first settling time may be greater than the lower threshold limit and less than the upper threshold limit, then the system 102 may generate the first anomaly alert. In yet another exemplary embodiment, if the first settling time may be greater than the upper threshold limit, then the system 102 may generate the first anomaly alert.

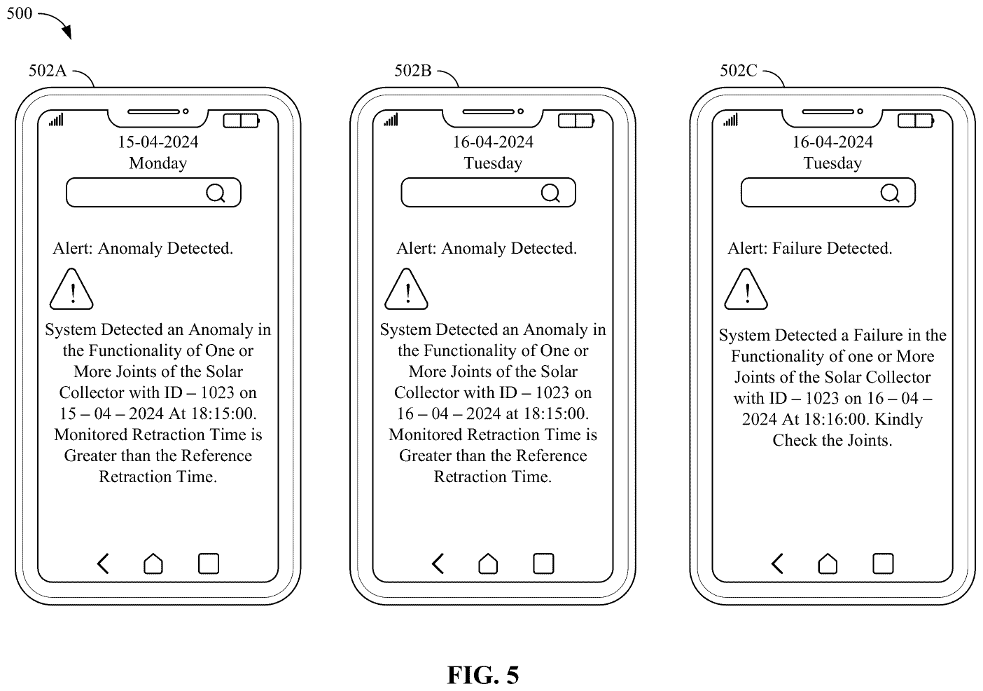

At 310, a first alert output operation may be executed. In the first alert output operation, the system 102 may be configured to output the first alert based on the detected first anomaly. In an exemplary embodiment, the system 102 may output the first alert on the user device 108 associated with the user 112. For example, the system 102 may notify the user 112 when the first anomaly occurs in the first retraction process of the solar collector 104. The first alert may be, but not limited to, a text message notification on the user device 108, or an email notification on the user device 108 as described in FIG. 5.

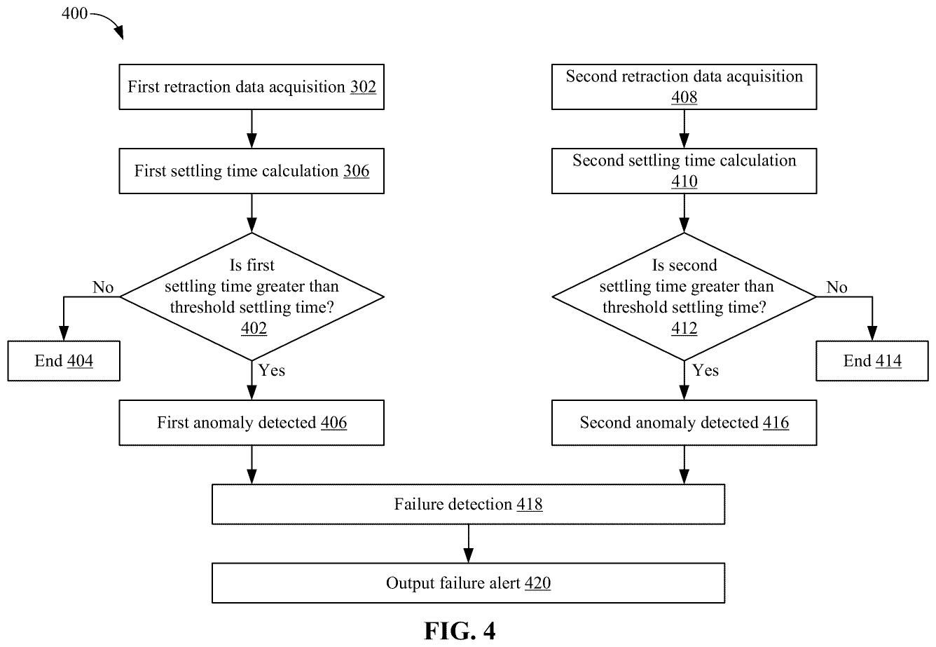

FIG. 4 is a flowchart that illustrates an exemplary method for failure detection in solar collectors, in accordance with an embodiment of the disclosure. FIG. 4 is explained in conjunction with elements from FIGS. 1, 2, and 3. With reference to FIG. 4, there is shown a flowchart 400 that illustrates exemplary operations from 402 to 420 as described herein.

In an embodiment, the system 102 may be configured to receive the first retraction data 204A associated with the first retraction process of the solar collector 104. Further, the system 102 may be configured to perform the first settling time calculation operation (described at 306) to calculate the first settling time of the first retraction process of the solar collector 104. The details about the first retraction data acquisition operation 302 and the first settling time calculation 306 operations are provided in FIG. 3.

At 402, the system 102 may be configured to compare if the first settling time associated with the first retraction process of the solar collector 104 is greater than the threshold settling time. In an exemplary embodiment, the first settling time and the threshold settling time may be compared to detect the first anomaly in the functionality of the one or more joints of the solar collector 104. For example, if the compared first settling time is greater than the threshold settling time, then the system 102 may detect the first anomaly in the functionality of the one or more joints of the solar collector 104. In an embodiment, based on the first anomaly detected 406, the system 102 may output the first alert on the user device 108 associated with the user 112. Further, based on the compared value of the first settling time being equal to the threshold settling time, the system 102 may detect efficient functioning of the one or more joints of the solar collector 104, and the detection process for the first anomaly may come to an end at 404.

At 408, the system 102 may be configured to receive the second retraction data 204B from the one or more databases 106. The second retraction data 204B may include the second retraction time associated with the second retraction process of the solar collector 104 from the first position to the second position. Further, the first retraction process may occur at the first time and the second retraction process may occur at the second time which may be different from the first time.

In an exemplary embodiment, the first time may be associated with the current day of operation. Further, the second time may be associated with the historical time period (say yesterday). The historical time period corresponds to, but is not limited to, 1 day before the current day of operation, 2 days before the current day of operation, 3 days before the current day of operation, 1 week before the current day of operation, 2 weeks before the current day of operation, 4 weeks before the current day of operation, 1 month before the current day of operation, and 1 year before the current day of operation.

At 410, the system 102 may be configured to calculate a second settling time associated with the second retraction process of the solar collector 104 based on the second retraction time and the reference retraction time. In an exemplary embodiment, the system 102 may receive the second retraction time associated with the second retraction process of the solar collector 104 from the one or more databases 106. Further, the system 102 may retrieve the reference retraction time 306B associated with the retraction process of the solar collector 104. The system 102 may further calculate the second settling time by determining the difference between the second settling time and the reference retraction time. For example, if the second retraction time associated with the second retraction process may be, for example, but not limited to, 30 seconds and the reference retraction time 306B associated with the reference retraction process may be, for example, but not limited to, 20 seconds, then the difference of 10 seconds between the second retraction process and the reference retraction process may be considered as the second settling time.

At 412, the system 102 may be further configured to compare if the second settling time associated with the second retraction process of the solar collector 104 is greater than the threshold settling time. In an exemplary embodiment, the second settling time and the threshold settling time may be compared to detect the second anomaly in the functionality of the one or more joints of the solar collector 104. For example, if the compared second settling time is greater than the threshold settling time, then the system 102 may detect the second anomaly in the functionality of the one or more joints of the solar collector 104. In an embodiment, based on the second anomaly detected 416, the system 102 may generate the second alert on the user device 108 associated with the user 112. Further, based on the compared value of the first settling time being less than the threshold settling time, the system 102 may detect efficient functioning of the one or more joints of the solar collector 104 and the detection process for the second anomaly may come to an end at 414.

In an embodiment, the threshold settling time may be specified within a defined threshold range. The defined threshold range for the threshold settling time may include an upper threshold limit and a lower threshold limit. By way of example and not limitation, the upper threshold limit may be, 12 seconds, and the lower threshold limit may be, 10 seconds. In an exemplary embodiment, if the second settling time may be less than the upper threshold limit and greater than the lower threshold limit, then the system 102 may not generate the second anomaly alert and the functionality of the one or more joints of the solar collector 104 may be considered as healthy. In another exemplary embodiment, if the second settling time may be greater than the lower threshold limit and less than the upper threshold limit, then the system 102 may generate the second anomaly alert. In yet another exemplary embodiment, if the second settling time may be greater than the upper threshold limit, then the system 102 may generate the second anomaly alert.

At 418, the system 102 may be configured to perform failure detection in the functionality of the one or more joints of the solar collector 104. The system 102 may detect the failure in the functionality of the one or more joints of the solar collector 104 based on at least one of the detected first anomaly and the detected second anomaly. In an exemplary embodiment, if the system 102 detects the first anomaly and the second anomaly, then the system 102 may detect the failure in the functionality of the one or more joints of the solar collector 104.

At 420, the system 102 may be configured to output the failure alert based on the detected failure of the one or more joints of the solar collector 104. The system 102 may generate the failure alert on the user device 108 associated with the user 112. The details about the failure alert are provided in FIG. 5.

FIG. 5 illustrates exemplary alerts on the user device 108, in accordance with an embodiment of the disclosure. FIG. 5 is explained in conjunction with elements from FIGS. 1, 2, 3, and 4. With reference to FIG. 5, there is shown a user interface 500 that illustrates the generation of the first alert, the second alert, and the failure alert on the user device 108.

At 502A, the first anomaly associated with the first retraction process detected in the functionality of the one or more joints of the solar collector 104 may be displayed on the user device 108 associated with the user 112. The first anomaly may be displayed in the form of the first alert outputted by the alert generation module 202D. The displayed first alert may include at least a message to the user 112 indicating the detected first anomaly, an identifier (ID) of the solar collector 104 having the first anomaly, a date on which the first anomaly was detected, and a time at which the first anomaly is detected.

In an exemplary embodiment, the anomaly detection module 202B detects the first anomaly on a first date at the first time. The first date may be, for example, Apr. 15, 2024. The first time may be, for example, 18:15:00. The alert generation module 202D outputs the first alert on the user device 108 associated with the user 112 in the form of a message. For example, the message may be “Alert: Anomaly detected. System detected an anomaly in the functionality of one or more joints of the solar collector with ID-1023 on 15-04-2024 at 18:15:00. Monitored retraction time is greater than the reference retraction time.”

At 502B, the second anomaly associated with the second retraction process detected in the functionality of the one or more joints of the solar collector 104 may be displayed on the user device 108 associated with the user 112. The second anomaly may be displayed in the form of the second alert outputted by the alert generation module 202D. The displayed second alert may include at least a message to the user 112 indicating the detected second anomaly, an id of the solar collector 104 having the second anomaly, a date on which the second anomaly is detected, and a time at which the second anomaly is detected.

In an exemplary embodiment, the anomaly detection module 202B detects the second anomaly on a second date at a second time. The second date may be, for example, Apr. 16, 2024. The second time may be, for example, 18:15:00. The alert generation module 202D outputs the second alert on the user device 108 associated with the user 112 in the form of a message. For example, the message may be “Alert: Anomaly detected. System detected an anomaly in the functionality of one or more joints of the solar collector with ID-1023 on 16-04-2024 at 18:15:00. Monitored retraction time is greater than the reference retraction time.”

At 502C, the failure detected in the functionality of the one or more joints of the solar collector 104 based on the detected first anomaly, and the detected second anomaly may be displayed on the user device 108 associated with the user 112. The failure may be displayed in the form of the failure alert outputted by the alert generation module 202D. The displayed failure alert may include at least a message to the user 112 indicating the detected failure, the ID of the solar collector 104 having the failure, the date on which the failure is detected, and the time at which the failure is detected.

In an exemplary embodiment, the failure detection module 202C detects the failure on a third date at a third time. The third date may be, for example, Apr. 16, 2024. The third time may be, for example, 18:16:00. The alert generation module 202D outputs the failure alert on the user device 108 associated with the user 112 in the form of a message. For example, the message may be “Alert: Failure detected. System detected a failure in the functionality of one or more joints of the solar collector with ID-1023 on 16-04-2024 at 18:16:00. Kindly check the joints.”

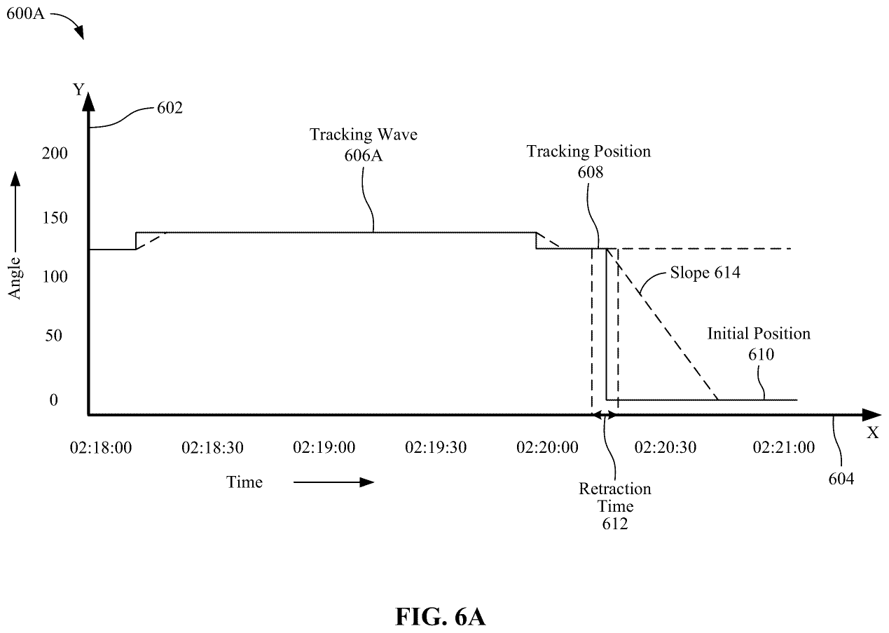

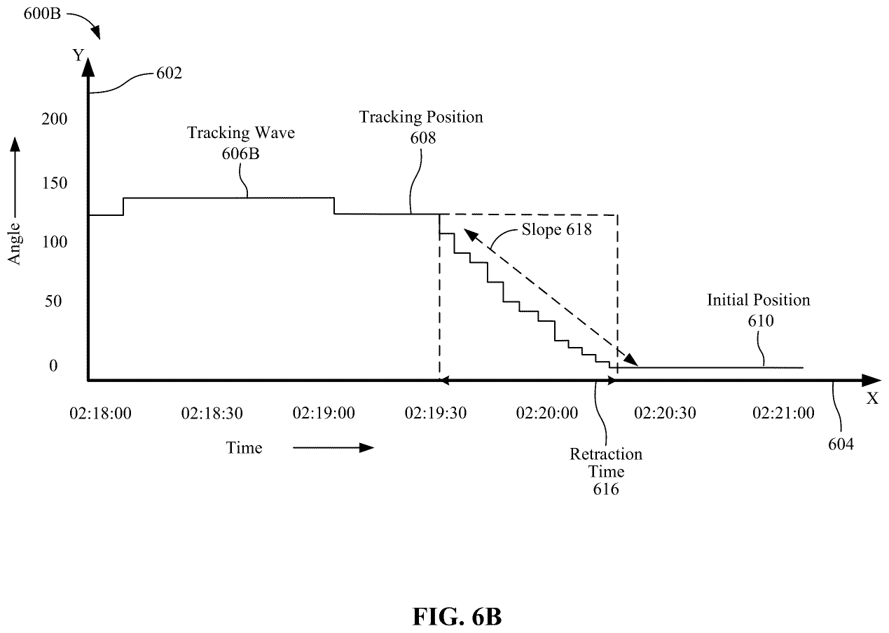

FIG. 6A illustrates a graphical representation 600A depicting an ideal retraction process of the solar collector 104 in accordance with an example embodiment. FIG. 6A is explained in conjunction with the elements of FIGS. 1, 2, 3, 4, and 5. With reference to FIG. 6, there is shown a graph that depicts the ideal retraction process of the solar collector 104.

In an embodiment, y-axis 602 may correspond to an angle. While tracking the sun, the movable part of the solar collector 104 may rotate thereby changing an angle between the movable part and a fixed section of the solar collector 104. The movable part of the solar collector 104 may correspond to the aperture or the absorber. Such a change in angle may be indicated by the y-axis 602. For example, the movable part may rotate and change its angle from 50 degrees to 70 degrees and further change the angle from 70 degrees to 100 degrees. The y-axis 602 may indicate such a change in the angle as markings of 20 degrees and 30 degrees on the y-axis 602. In another embodiment, the y-axis 602 may represent a range of angles that would be traversed by the moving part of the solar collector 104 while tracking the sunlight. For example, the moving part of the solar collector 104 may rotate within a range of 0 to 180 degrees.

In an embodiment, the x-axis 604 corresponds to time. The x-axis 604 may indicate a duration of time during which the retraction process for the movable part of the solar collector 104 may be performed. The retraction process may include at least one of the first retraction process, the second retraction process, or the reference retraction process. For example, the retraction process of the solar collector 104 is performed between a time period. The time period may be, for example, but not limited to, 02:18:00. to 02:21:00. Further, the retraction process of the solar collector 104 may be performed at any time of the day, preferably when sunlight ceases to exist.

In an embodiment, a tracking wave 606A may represent a movement or movement behavior pattern of the solar collector 104. The tracking wave 606A may indicate the movement of the movable part of the solar collector 104 during the first retraction process of the solar collector 104. For example, the solar collector may be at 120 degrees at 02:18:00. and 140 degrees at 02:19:00. In an exemplary embodiment, the tracking wave 606A may indicate the movement of the movable part of the solar collector 104 during the second retraction process.

In an embodiment, the tracking position 608 may be a position at which the retraction process of the solar collector 104 may be triggered. Further, the tracking position 608 may correspond to a current angle or position that is attained by the movable part of the solar collector 104 before the tracking stops.

In an exemplary embodiment, the tracking position 608 may be, for example, the first position of the solar collector 104. Further, during the tracking mode, the movable part of the solar collector 104 tracks the sunlight. Further, when the mode of the solar collector is changed to the stop mode, i.e., when the retraction process may be triggered, the movable part of the solar collector 104 may stop tracking the sunlight at the tracking position 608 and start the retraction process of the movable part of the solar collector 104. For example, the retraction process is triggered at 02:20:15, and the position at which the retraction process is triggered (120 degrees) is tracking position 608.

In an embodiment, the initial position 610 may correspond to the initial or rest position of the solar collector 104 at the initial angle, for example, 0 degrees. The solar collector 104 may start tracking the sun by rotating at different angles from the initial position 610 to finally, the tracking position 608, such as 120 degrees. During the retraction process, the movable part may move from the tracking position 608 to the initial position 610. In an exemplary embodiment, the initial position 610 may be, for example, the second position of the solar collector 104. Further, the retraction process may be triggered at 02:20:15, and the movable part of the solar collector 104 may start to move from the tracking position 608 (120 degrees) towards the initial position 610 (0 degrees).

In an embodiment, the time taken to perform the retraction process may correspond to a retraction time 612. The retraction time 612 may indicate the amount of time taken by the solar collector 104 to change its position or angle from the tracking position 608 to the initial position 610. In an exemplary embodiment, if the retraction time 612 may be small, for example, close to zero, then the retraction time 612 may indicate an ideal retraction time of the solar collector 104. Further, the retraction time 612 may indicate the expected or normal functioning of the one or more joints of the solar collector 104. For example, if the retraction process is triggered at 02:20:15, then the solar collector 104 moves from tracking position 608 (120 degrees) to the initial position 610 (0 degrees). Further, the solar collector 104 may reach the initial position 610 at 02:20:20 indicating an end of the retraction process.

In another exemplary embodiment, in the case of the solar collector 104 functioning ideally, a settling time of the retraction process may be less than or equal to the settling time threshold. To this end, the solar collector 104 performing the retraction process having ideal behaviour may be considered as healthy.

In an embodiment, a slope 614 of a change in angle overtime during the retraction time 612 may indicate a retraction speed of the movable part of the solar collector 104. In an exemplary embodiment, the ideal retraction time may result in slope 614 being high. This may indicate that the retraction speed may be high. A high value of slope 614 may further indicate the normal functioning of the one or more joints of the solar collector 104.

In an exemplary embodiment, the anomaly detection module 202B may compare the retraction time 612 with the reference retraction time, or the retraction speed indicated by the slope 614 with the reference retraction speed to identify anomalies in the functionality of the one or more joints of the solar collector 104. Further, if the anomaly may be identified, such as an increase in retraction time of the solar collector 104 over a period of time. For example, if retraction time increases by 20 minutes over 4 days, then the failure in the functionality of the one or more joints of the solar collector 104 may be detected.

FIG. 6B illustrates a graphical representation 600B depicting an anomaly in the retraction process of the solar collector 104 in accordance with an example embodiment. FIG. 6B is explained in conjunction with the elements of FIGS. 1, 2, 3, 4, 5, and 6A. With reference to FIG. 6B, there is shown a graph that depicts the anomaly in the retraction process of the solar collector 104.

In an embodiment, y-axis 602 may correspond to an angle. While tracking the sun, the movable part of the solar collector 104 may rotate thereby changing an angle between the movable part and a fixed section of the solar collector 104. Such a change in angle may be indicated by the y-axis 602.

In another embodiment, the y-axis 602 of the graphical representation 600B may represent a range of angles that may be traversed by the moving part of the solar collector 104 while tracking the sunlight. For example, the moving part of the solar collector 104 may rotate within a range of 0 to 180 degrees.

In an embodiment, the x-axis 604 may correspond to time. The x-axis 604 may indicate the duration of time during which the retraction process for the movable part of the solar collector 104 may be performed. The retraction process may include at least one of the first retraction process, the second retraction process, and the reference retraction process. For example, the retraction process of the solar collector 104 may be performed between a time period. The time period may be, for example, but not limited to, 02:18:00 to 02:21:00. Further, the retraction process of the solar collector 104 may be performed at any time of the day, preferably when sunlight ceases to exist.

In an embodiment, a tracking wave 606B may indicate the movement of the movable part of the solar collector 104 during the first retraction process of the solar collector 104. For example, the solar collector may be at 120 degrees at 02:18:00. and 140 degrees at 02:19:00. In an alternate embodiment, the tracking wave 606B may indicate the movement of the movable part of the solar collector 104 during the second retraction process.

In an embodiment, the tracking position 608 may be a position at which the retraction process of the solar collector 104 may be triggered. Further, the tracking position 608 may correspond to a current angle or position that is attained by the movable part of the solar collector 104 before the tracking of the sun stops.

In an exemplary embodiment, the tracking position 608 may be, for example, the first position of the solar collector 104. Further, during the tracking mode, the movable part of the solar collector 104 tracks the sunlight. When the mode of the solar collector 104 is changed to the stop mode, the retraction process may be triggered, the movable part of the solar collector 104 may stop tracking the sunlight at the tracking position 608 and start the retraction process of the movable part of the solar collector 104. For example, the retraction process is triggered at 02:19:30, and the position at which the retraction process is triggered (120 degrees) is the tracking position 608.

In an exemplary embodiment, the initial position 610 may be, for example, the second position of the solar collector 104. Further, the retraction process is triggered at 02:19:30, the movable part of the solar collector 104 starts moving from the tracking position 608 (120 degrees) towards the initial position 610 (0 degrees).

In an embodiment, the time taken to perform the retraction process of the movable part of the solar collector 104 may correspond to a retraction time 616. The retraction time 616 may indicate the amount of time taken by the solar collector 104 to change its angle from the tracking position 608 to the initial position 610. In an exemplary embodiment, if the retraction time 616 may be high, for example, but not limited to, 5 seconds, 10 seconds, 15 seconds, and 20 seconds, then the solar collector 104 may take an increased amount of time to change its position from the first position to the second position. Further, a high value of the retraction time 616 may indicate failure in the functioning of the one or more joints of the solar collector 104. For example, if the retraction process is triggered at 02:19:00, then the solar collector 104 moves from tracking position 608 (120 degrees) to the initial position 610 (0 degrees). Further, the solar collector 104 reaches the initial position 610 at 02:20:20 indicating an end of the retraction process.

In another exemplary embodiment, in the case of the failure in the one or more joints of the solar collector 104, the settling time of the retraction process may be more than the settling time threshold. The settling time being greater than the threshold settling time may indicate the failure in the one or more joints of the solar collector.

In an embodiment, a slope 618 of the change in angle over time during the retraction time 616 may indicate the retraction speed of the movable part of the solar collector 104. In an exemplary embodiment, the slope 618 may be low as the retraction time 616 for the retraction speed of the movable part of the solar collector 104 may be less. The less retraction speed may result in the slope 618 being low. A low value of the slope 618 may further indicate the failure in the functioning of the one or more joints of the solar collector 104.

In an exemplary embodiment, the anomaly detection module 202B may compare the retraction time 612 with the reference retraction time, or the retraction speed indicated by the slope 614 with the reference retraction speed to identify anomalies in the functionality of the one or more joints of the solar collector 104. Further, if the anomaly may be identified, such as an increase in retraction time of the solar collector 104 over a period of time, then the failure in the functionality of the one or more joints of the solar collector is detected.

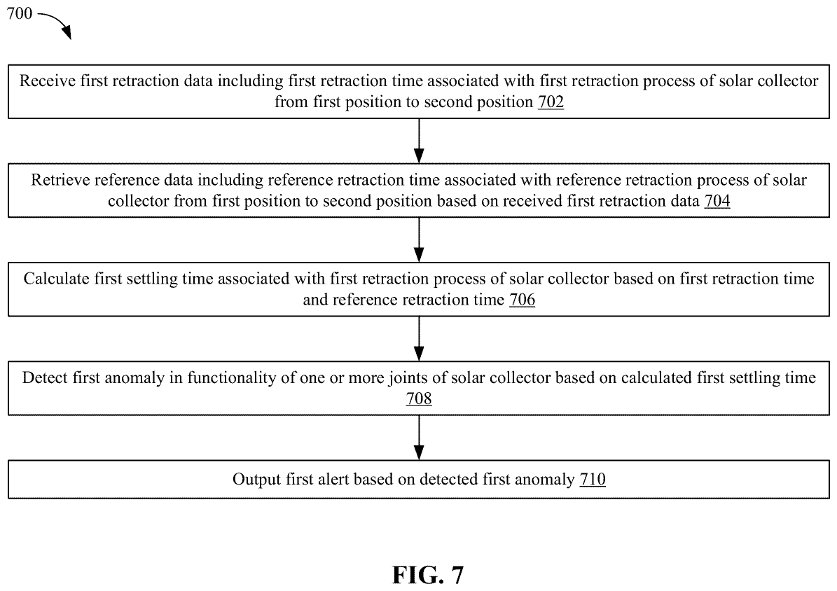

FIG. 7 is a flowchart 700 that illustrates an exemplary method for failure detection in solar collectors, in accordance with an embodiment of the disclosure. FIG. 7 is explained in conjunction with elements from FIGS. 1, 2, 3, 4, 5, 6A and 6B. With reference to FIG. 7, there is shown the flowchart 700. The operations of the exemplary method may be executed by any computing system, for example, by the system 102 of FIG. 1 or the processor 202 of FIG. 2. The operations of the flowchart 700 may start at 702.

At 702, the first retraction data 204A including the first retraction time 306A associated with the first retraction process of the solar collector 104 from the first position to the second position may be received. In an embodiment, the one or more processors 202 may be configured to receive the first retraction data 204A including the first retraction time 306A associated with the first retraction process of the solar collector 104 from the first position to the second position.

At 704, the reference data 204C including the reference retraction time 306B associated with the reference retraction process of the solar collector 104 from the first position to the second position may be retrieved based on the received first retraction data 204A. In an embodiment, the one or more processors 202 may be configured to retrieve the reference data 204C including the reference retraction time 306B associated with the reference retraction process of the solar collector 104 from the first position to the second position.

At 706, the first settling time 402 associated with the first retraction process of the solar collector 104 may be calculated based on the first retraction time 306A and the reference retraction time 306B. In an embodiment, the one or more processors 202 may be configured to calculate the first settling time 402 associated with the first retraction process of the solar collector 104 based on the first retraction time 306A and the reference retraction time 306B.

At 708, the first anomaly in the functionality of the one or more joints of the solar collector 104 may be detected based on the calculated first settling time. In an embodiment, the one or more processors 202 may be configured to detect the first anomaly in the functionality of the one or more joints of the solar collector 104 based on the calculated first settling time 402.

At 710, the first alert may be outputted based on the detected first anomaly. In an embodiment, the one or more processors 202 may be configured to output the first alert based on the detected first anomaly.

Accordingly, blocks of the flowchart 700 support combinations of means for performing the specified functions and combinations of operations for performing the specified functions. It will also be understood that one or more blocks of the flowchart 700 can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

Various embodiments of the disclosure may provide a non-transitory computer readable medium having stored thereon computer executable instructions, which when executed by one or more processors (such as the processor 202), cause the one or more processors to carry out operations to operate a system (e.g., the system 102) for failure detection in solar collectors. The operations include receiving first retraction data including a first retraction time associated with a first retraction process of a solar collector from a first position to a second position. The operations may further include retrieving reference data including a reference retraction time associated with a reference retraction process of the solar collector from the first position to the second position based on the received first retraction data. Further, the operations may include calculating a first settling time associated with the first retraction process of the solar collector based on the first retraction time and the reference retraction time. The operations may further include detecting a first anomaly in a functionality of one or more joints of the solar collector based on the calculated first settling time. Further, the operations may include outputting a first alert based on the detected first anomaly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer-executable instructions; and
one or more processors coupled to the memory, wherein the one or more processors are configured to:
receive first retraction data comprising a first retraction time associated with a first retraction process of a solar collector from a first position to a second position;
retrieve reference data comprising a reference retraction time associated with a retraction process of the solar collector from the first position to the second position based on the received first retraction data;
calculate a first settling time associated with the first retraction process of the solar collector based on the first retraction time and the reference retraction time;
detect a first anomaly in a functionality of one or more joints of the solar collector based on the calculated first settling time; and
output a first alert based on the detected first anomaly.

2. The system of claim 1, wherein the one or more processors are further configured to:
receive second retraction data comprising a second retraction time associated with a second retraction process of the solar collector from the first position to the second position, wherein the first retraction process occurs at a first time and the second retraction process occurs at a second time;
calculate a second settling time associated with the second retraction process of the solar collector based on the second retraction time and the reference retraction time;
detect a second anomaly in the functionality of the one or more joints of the solar collector based on the calculated second settling time; and
output a second alert based on the detected second anomaly.

3. The system of claim 2, wherein the one or more processors are further configured to:
detect a failure in the functionality of the one or more joints of the solar collector based on at least one of the detected first anomaly and the detected second anomaly; and
output a failure alert based on the detected failure of the one or more joints of the solar collector.

4. The system of claim 1, wherein the first retraction data associated with the first retraction process of the solar collector further comprises at least one of: first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.

5. The system of claim 1, wherein the reference data associated with the solar collector further includes at least one of: first position information associated with the first position of the solar collector, second position information associated with the second position of the solar collector, or a reference retraction slope of the solar collector.

6. The system of claim 1, wherein the one or more processors are further configured to:
compare the first settling time associated with the first retraction process of the solar collector with a threshold settling time; and
detect the first anomaly in the functionality of the one or more joints of the solar collector based on the comparison.

7. The system of claim 6, wherein the one or more processors are further configured to detect the first anomaly in the functionality of the one or more joints of the solar collector based on a determination that the first settling time is greater than the threshold settling time.

8. The system of claim 1, wherein the one or more processors are further configured to:
receive a user input associated with an initiation of the first retraction process of the solar collector from the first position to the second position; and
receive the first retraction data based on the received user input.

9. The system of claim 1, wherein the one or more processors are further configured to store the calculated first settling time associated with the first retraction process of the solar collector in one or more databases.

10. A method comprising:
receiving first retraction data comprising a first retraction time associated with a first retraction process of a solar collector from a first position to a second position;
retrieving reference data comprising a reference retraction time associated with a retraction process of the solar collector from the first position to the second position based on the received first retraction data;
calculating a first settling time associated with the first retraction process of the solar collector based on the first retraction time and the reference retraction time;
detecting a first anomaly in a functionality of one or more joints of the solar collector based on the calculated first settling time; and
outputting a first alert based on the detected first anomaly.

11. The method of claim 10, further comprising:
receiving second retraction data comprising a second retraction time associated with a second retraction process of the solar collector from the first position to the second position, wherein the first retraction process occurs at a first time and the second retraction process occurs at a second time;
calculating a second settling time associated with the second retraction process of the solar collector based on the second retraction time and the reference retraction time;
detecting a second anomaly in the functionality of the one or more joints of the solar collector based on the calculated second settling time; and
outputting a second alert based on the detected second anomaly.

12. The method of claim 11, further comprising:
detecting a failure in the functionality of the one or more joints of the solar collector based on the detected first anomaly and the detected second anomaly; and
outputting a failure alert based on the detected failure of the one or more joints of the solar collector.

13. The method of claim 10, wherein the first retraction data associated with the first retraction process of the solar collector further comprises at least one of: first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.

14. The method of claim 10, wherein the reference data associated with the solar collector further includes at least one of: first position information associated with the first position of the solar collector, second position information associated with the second position of the solar collector, or a reference retraction slope of the solar collector.

15. The method of claim 10, further comprising:
comparing the first settling time associated with the first retraction process of the solar collector with a threshold settling time; and
detecting the first anomaly in the functionality of the one or more joints of the solar collector based on the comparison.

16. The method of claim 15, wherein the method further comprises detecting the first anomaly in the functionality of the one or more joints of the solar collector based on a determination that the first settling time is greater than the threshold settling time.

17. The method of claim 10, further comprising:
receiving a user input associated with an initiation of the first retraction process of the solar collector from the first position to the second position; and
receiving the first retraction data based on the received user input.

18. The method of claim 10, wherein the method further comprises storing the calculated first settling time associated with the first retraction process of the solar collector in one or more databases.

19. A computer programmable product comprising a non-transitory computer readable medium having stored thereon computer executable instructions, which when executed by one or more processors, cause the one or more processors to carry out operations comprising:
receiving first retraction data comprising a first retraction time associated with a first retraction process of a solar collector from a first position to a second position;
retrieving reference data comprising a reference retraction time associated with a retraction process of the solar collector from the first position to the second position based on the received first retraction data;
calculating a first settling time associated with the first retraction process of the solar collector based on the first retraction time and the reference retraction time;
detecting a first anomaly in a functionality of one or more joints of the solar collector based on the calculated first settling time; and
outputting a first alert based on the detected first anomaly.

20. The computer programmable product of claim 19, wherein the first retraction data associated with the first retraction process of the solar collector further comprises at least one of:
first position information associated with the first position of the solar collector, second position information associated with the second position of the solar collector, a first timestamp associated with an initiation of the first retraction process of the solar collector, a second timestamp associated with an ending of the first retraction process of the solar collector, speed information associated with the first retraction process of the solar collector, or slope information associated with the solar collector.
